(19) United States
(12) Patent Application Publication
(10) Pub. No.: US 2025/0302079 A1
(43) Pub. Date: Oct. 2, 2025

(54) METHOD OF PRODUCING A FOOD PRODUCT COMPRISING GUTTED AND PLUCKED POULTRY MEAT MATERIAL

(71) Applicant: NE INNOVATIONS OY, Helsinki (FI)

(72) Inventor: Santtu VEKKELI, Helsinki (FI)

(21) Appl. No.: 18/863,157

(22) PCT Filed: May 5, 2023
(86) PCT No.: PCT/FI2023/050246

§ 371 Date: Nov. 5, 2024

(30) Foreign Application Priority Data
May 5, 2022 (FI) 20225390

(51) Int. Cl. A23L 13/40; A23J 3/04; A23J 3/14; A23J 3/26; A23L 13/50; A23L 13/60

(52) U.S. Cl. CPC A23L 13/426; A23J 3/04; A23J 3/14; A23J 3/26; A23L 13/52; A23L 13/55; A23L 13/60

(57) ABSTRACT

It is disclosed a method of producing a food product comprising a poultry meat material and a plant-based food material, comprising the steps of: providing a gutted and plucked poultry meat material comprising bones; providing a plant-based food material; grinding the gutted and plucked poultry meat material with a meat grinder having a particle size of at most 5 mm to provide a ground poultry mass; adding the plant-based food material to the ground poultry mass to provide a poultry/plant mass mixture; subjecting the poultry/plant mass mixture to a wet extrusion to provide an extruded mass; mincing the extruded mass with a colloid mill to provide a minced extruded mass as a food product.

### FIELD OF THE INVENTION

The present invention relates to a method of producing a food product. More particularly, the invention relates to a method of producing a food product by extrusion and colloid milling from poultry including undervalued parts of poultry.

### BACKGROUND OF THE INVENTION

Extrusion is widely used in the manufacture of various food products. Broadly, extrusion is a continuous process which uses an extruder having one or two screws. The extruder provides transport, compression, mixing, cooking, shearing, heating, cooling and shaping of raw material to final products.

U.S. Pat. No. 5,853,790 discloses a method for commercial preparation of poultry meat for human consumption by using extrusion. The method effectively maximizes the use of poultry meat from an entire poultry carcass, and enhances the value of all of the meat from a bird carcass. The meat portions of whole birds are deboned in the method.

RU 2223673 discloses a method for producing combined extrusion products from meat and vegetable raw materials. Poultry meat used in the method is mechanically deboned. Veins, tendons and skin may be used in the production. It has now been found that a food product for human consumption with satisfactory organoleptic properties, such appealing taste and good mouthfeel, comprising a poultry meat material and a plant-based food material, may be produced from undervalued parts of poultry meat material containing bones, and optionally additionally, e.g., hard tissues, tendons, skin and/or cartilages. Poultry meat from an entire poultry carcass may be effectively used and converted to a valuable food product with consumer acceptable organoleptic properties. The satisfactory organoleptic properties of the food product are provided by grinding an extruded food mass containing poultry meat material and a plant-based food material using a colloid mill.

### BRIEF DESCRIPTION OF THE INVENTION

In an aspect, the present invention provides a method for producing a food product from a poultry meat material and a plant-based food material. The method effectively utilizes all meat from bird carcass including bones, and optionally hard tissues, tendons, skin and/or cartilages.

The invention thus provides a sustainable method in which whole gutted and plucked bird may be effectively used in the production of a ready-to-consume food product for human consumption providing environmental benefits. Additionally, the food product can be used as an ingredient or an extender and combined with other food materials to produce a wide range of food compositions.

The food product produced by the method of the invention is also suitable as an animal feed.

The invention also provides a method in which undervalued parts of a bird or of low hygienic quality may be used providing economic benefits in that the product can be offered at a lower cost.

The invention further provides a method of producing a food product with an increased nutritional value.

Further, the invention provides a method of producing a food product which enables reduction of global meat production providing environmental benefits.

The invention also provides a method of producing a food product having a high collagen content.

The invention further provides a method of producing a food product having an increased liquid absorption capacity.

The invention also provides a method of producing a food product with high microbiological quality and substantially eliminated Salmonella bacteria.

In another aspect, the invention provides a food composition comprising a food product produced by the method of the invention.

In an aspect, the invention provides use of a food product produced by the method of the invention in the food composition.

In further aspect, the invention provides an apparatus comprising means for implementing the method of the invention.

### BRIEF DESCRIPTION OF THE DRAWINGS

FIG. 1 generally illustrates a process flow diagram of an embodiment of the method of the invention.

FIG. 2 illustrates an embodiment of an apparatus of the invention.

FIG. 3 illustrates hard tissue particle size of food products.

### DETAILED DESCRIPTION OF THE INVENTION

In an aspect, the present invention provides a method of producing a food product comprising a poultry meat material and a plant-based food material, comprising the steps of:
providing a gutted and plucked poultry meat material comprising bones,
providing a plant-based food material,
grinding the gutted and plucked poultry meat material with a meat grinder having a particle size of at most 5 mm to provide a ground poultry mass,
adding the plant-based food material to the ground poultry mass to provide a poultry/plant mass mixture,
subjecting the poultry/plant mass mixture to a wet extrusion to provide an extruded mass,
mincing the extruded mass with a colloid mill to provide a minced extruded mass as a food product.

Here, the expression “poultry/plant mass mixture” means a mixture of the ground poultry mass and the plant-based food material”.

The percentages of the various constituents throughout in the present application are given on weight basis.

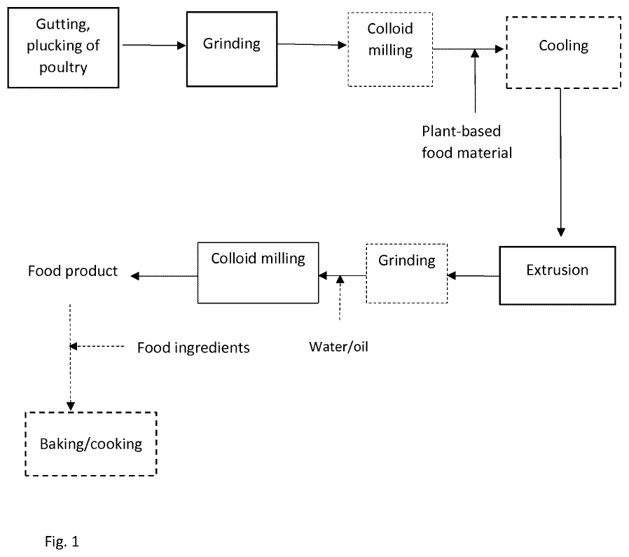

FIG. 1 illustrates an embodiment of the method of the invention. The dotted line illustrates optional method steps. The method may include further optional method steps not shown in the figure.

Poultry meat material suitable for use in the method of the invention includes, but is not limited to, chickens, turkeys, ducks, and geese. In an embodiment of the invention, the poultry is chicken.

The gutted and plucked poultry meat material comprises bones. The content of the bones in the gutted and plucked poultry meat material may vary in the range of about 10 wt-% to about 60 wt-%. Use of increased amount of bones in the gutted and plucked poultry meat material beneficially results in an increased amount of calcium in the final food product.

In an embodiment, the gutted and plucked poultry meat material further contains hard tissues, tendons, skin and/or cartilages, and can be provided by legs, necks, skin and/or heads of poultry.

The gutted and plucked poultry meat material is ground to crush bones and other hard tissues and to provide a ground poultry mass which is in a suitable form to be fed to a wet extrusion. The grinding is carried out with a meat grinder having a hole size of at most 5 mm. In an embodiment, the meat grinder has a hole size in the range of about 2 mm up to 5 mm.

In an embodiment, the ground poultry mass is subjected to a colloid mill to further crush bone particles to smaller pieces. Generally, “colloid mill” is a machine which has a high-speed rotor and a stator providing superfine grinding results along with simultaneous emulsifying, homogenizing, and dispersing. The rotor pushes the material into small gaps between the rotor and stator causing intense mechanical shear. In the present invention, colloid milling provides a homogenous, ultra-fine bone particles of bone-containing poultry mass and beneficially enhances softening of bone particles in the subsequent wet extrusion. In an embodiment, colloid milling of the ground poultry mass provides bone particles having an average particle size of at most 500 μm.

In an embodiment, the method of the invention involves two colloid milling steps, i.e., colloid milling of the ground poultry mass and colloid milling of the extruded mass.

After grinding the gutted and plucked poultry meat material with a meat grinder, and optional further grinding with a colloid mill, the obtained ground poultry mass is mixed with a plant-based food material. Any food-grade plant-based food material is suitable to be added to the ground poultry mass. The plant-based food material includes, but is not limited to, a food material which is rich in protein, carbohydrate and/or fibre. In an embodiment, the plant-based food material comprises soy protein, pea protein, cereal proteins, broad bean protein, maize protein, potato starch, maize starch, or any mixture thereof. In an embodiment, the plant-based food material is provided as finely ground powder. In an embodiment, the plant-based food material is thoroughly mixed with the ground poultry mass to provide a uniform poultry/plant mass mixture.

The plant-based food material is added to the ground poultry mass in an amount so as to provide a food product containing about 5 wt-% to about 50 wt-% of the plant-based food material. In an embodiment, the food product contains about 10 wt-% to about 30 wt-% of the plant-based food material.

In an embodiment, the food product contains about 50 wt-% to about 95 wt-% of the gutted and plucked poultry meat material. In another embodiment, the food product contains about 70 wt-% to about 90 wt-% of the gutted and plucked poultry meat material.

In an embodiment, the poultry/plant mass mixture is cooled to a temperature of about −25° C. to about 6° C. Cooling of the poultry/plant mass mixture improves microbiological quality of the mass mixture before feeding it to the extrusion process.

The poultry/plant mass mixture is subjected to a wet extrusion to provide an extruded mass. In context of the present invention, the term “wet extrusion” means that the poultry/plant mass mixture to be extruded has a moisture content of at least 30%. In an embodiment, the moisture content of poultry/plant mass mixture is in the range of 30% to about 70%. If the moisture content is lower than 30%, it may be difficult to carry out the extrusion process, since the mass mixture in the extruder is dry. On the other hand, if the moisture content is higher than 70%, liquid is undesirably separated from the dry matter of the mass mixture.

The wet extrusion may be carried out with a single-screw or twin-screw extruder. Shearing and tearing combined with moisture in the extrusion step causes softening of the hard tissues of poultry and provides a unique structure to the final food product.

In an embodiment, the wet extrusion is performed at a temperature of about 100° C. to about 400° C. Depending on the extruder used in the method, the extruder has to contain at least one heating segment where the temperature is at least 100° C. In addition, there may be further heating segments where the extrusion may be performed below 100° C., e.g., at 70° C. In an embodiment of the invention, an extruder is used which contains several heating segments each operated at a different temperature. In an embodiment, the temperature of the heating segments increases when the mass moves forward in the extruder.

The duration of the wet extrusion is dependent on the apparatus construction and settings.

In an embodiment, the wet extrusion is performed using about 100 rpm to about 1000 rpm speed. In another embodiment, the wet extrusion is performed using about 170 rpm to about 600 rpm speed. In an embodiment, about 170 rpm is employed in the wet extrusion.

In an embodiment, the wet extrusion of the ground poultry mass provides an extruded mass having a temperature of at least 100° C.

In an embodiment, the extruded mass is cooled to a temperature of about +60° C. to about −30° C. In an embodiment, cooling of the extruded mass is performed in an extruder before the extruded mass is discharged from the extruder. Cooling in the extruder is conveniently carried out in the cooling die. When the extruded mass is cooled in the extruder, the temperature of the mass discharged from the extruder may range from about 1° C. to about 80° C. In an embodiment, the temperature of the extruded mass is in the range from about 30° C. to about 60° C.

The extruded mass is then minced with a colloid mill to improve the sensory properties of the obtained food product. The colloid mill at this stage may be the same as or different from the colloid mill used for grinding the ground poultry mass.

To provide an acceptable food product made from hard tissues, smooth mouth feeling is a critical sensory property among consumers. In the present invention, extrusion of the poultry/plant mass mixture provides softened hard tissues. Colloid milling after the extrusion step provides smaller and further softened hard tissue particles. In the present invention, combination of extrusion of the poultry/plant mass mixture and colloid milling after the extrusion advantageously provides a food product of high quality, made from hard tissue raw material(s).

In an embodiment, water and/or oil is added to the extruded mass before colloid milling to enhance the performance of colloid milling. Grinding of the extruded mass with a colloid mill provides a food product containing bones with an average particle size of about 1 μm to about 500 μm. The colloid milled food product exhibits a smooth mouth feel without observable bone particles present.

The food product produced by the method of the invention has an increased liquid absorption capacity. Improved oil and water binding ability allows production of food products with improved mouthfeel and structure. Colloid milling after extrusion allows use of hard tissues containing collagen, such as bones, of poultry in the manufacture of food products with a high collagen content without need of addition of collagen from external sources.

The colloid milling of the extruded mass provides a food-grade product which is ready to be consumed as such.

Extrusion process decreases microbial load of poultry carcass enabling use of poultry of low hygienic quality. Microbial load is reduced by approximately 1000-109 fold during the process.

The extruded food product produced by the method of the invention may imitate the texture, flavour, and mouthfeel of meat.

The method of the invention provides a food product which exhibits an increased nutritional value. By using calcium-containing parts of poultry, i.e., bones, and optionally hard tissues, tendons, and/or cartilages, the calcium content of the food product produced by the method is increased compared with typical poultry meat products. In an embodiment, the food product has a calcium content of about 0.2% w/w to about 0.9% w/w. In another embodiment, the calcium content of the food product is about 0.2% w/w to about 0.7% w/w. In a further embodiment, the calcium content of the food product is about 0.2% w/w to about 0.5% w/w. In a still further embodiment, the calcium content of the food product is about 0.5% w/w to about 0.7% w/, such as about 0.52% w/w.

In an embodiment, the food product produced by the method of the invention has a collagen content of about 5 wt-% to about 80 wt-% based on the total protein content of the food product. In another embodiment, the food product produced by the method of the invention has a collagen content of about 10 wt-% to about 70 wt-%. In a further embodiment, the food product produced by the method of the invention has a collagen content of about 30 wt-% to about 60 wt-%.

In an embodiment, the method of the invention does not involve addition of collagen from external source(s).

In an embodiment, the extruded and colloid milled food product is heat-treated at a temperature ranging from about 110° C. to about 400° C. to further improve sensory properties and mouthfeel of the product. The heat treatment may be carried out, e.g., by cooking in oil, e.g., at 150-300° C., grilling, pan frying, drying by heat, e.g., at 200-400° C., freeze drying below −70° C., microwaving or infrared radiating.

The sensory properties of the food product may be further improved by adding ingredients typically used in food manufacture to the food product produced by the method of the invention, e.g., flavouring agents, aromas, salt, stabilizers, emulsifiers, carbohydrates, fibres, oils and fats, etc.

The food product may be combined with other food materials to provide a wide variety of food compositions having different appearance, taste and structure. Thus, in an aspect, the invention provides use of a food product produced by the method of the invention as an ingredient or extender in the production of food compositions. The food product may be combined, for example, with a plant-based food raw material or poultry meat material without bones, hard tissues, tendons, skin and/or cartilages. The food product produced by the method of the invention may be included in the food composition in an amount up to about 50% w/w without imparting any negative effect on the sensory properties of the food composition.

In another aspect, the invention provides a food composition comprising a food product produced by the method of the invention.

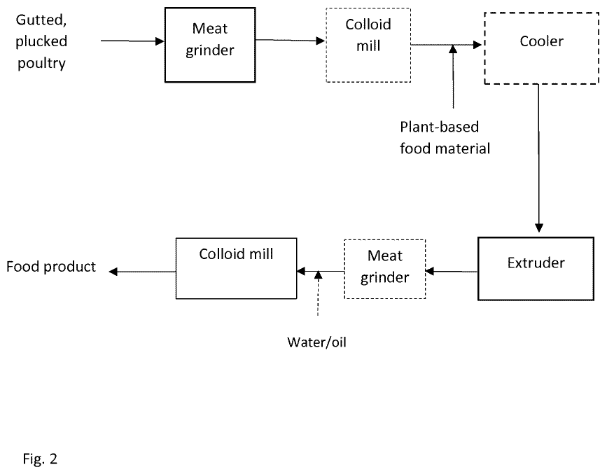

In a further aspect, the invention provides an apparatus for implementing the method of the invention, comprising means for implementing the method of the invention. An embodiment of the apparatus of the invention is illustrated in FIG. 2. The dotted line illustrates optional units. The apparatus may include further optional units not shown in the figure.

The following examples are presented for further illustration of the invention without limiting the invention thereto.

The calcium content of the food product was measured according to standard SFS-EN ISO 11885, 2009.

The level of aerobic microorganisms was measured according to standard NMKL 86:2013.

The amount of Salmonella was measured according to ISO/DIS 20976-2.

The hydroxyproline content of the food product was determined according to ISO 3496:1994. The collagen content of the food product was calculated from hydroxyproline content by using the coefficient 8.

### Example 1

70 kg of poultry carcass (with bones and skin) was minced with a meat grinder with a hole size of 2 mm. Hard tissue content of the sample was about 60%.

The ground poultry mass was then colloid milled to a fine mass with bone particles with approximately diameter of 100 μm. Milled mass was properly mixed with 30 kg of a soy concentrate powder (protein content of 66 wt-%). The resultant mixture was kept at approximately 4° C. The mixture was then loaded to a silo connected to a conveyor screw that was connected to a hopper with approximately 30 liters of volume. The mixture was led from the hopper with an auger and a screw to an extruder in a controlled manner at approximately 55 kg/h.

The mixture of ground poultry mass and a soy concentrate powder was led to an extruder which had a cooling die integrated therewith. The moisture content of the mixture was about 55% w/w. The mixture was extruded at 170 rpm. Heating zones of the extruder were adjusted to a temperature of 60° C., 70° C., 80° C., 100° C., 120° C., 150° C. and 170° C. First zone of the cooling die was set to 60° C. and last zone to 40° C. The extrusion process took about one minute.

The extruded mass exited the cooling die at a temperature of less than 100° C. Only a small amount of steam was released in the process. Solid mass and some amounts of separated oil exited the end of the cooling die.

The level of aerobic microorganisms of the solid mass obtained from the wet extrusion and that of the mixture of ground poultry mass and a soy concentrate powder to be fed to the wet extrusion, i.e., “raw material”) were measured at 30° C./72 h. The solid mass showed <100 pmy/g, while the raw material showed more than 30 000 000 pmy/g. The measured level of aerobic microorganisms indicates that a food grade product for human consumption was obtained.

The food product, i.e., solid mass, had a calcium content of 0.52% w/w.

The solid mass exhibited 7-log reduction of Salmonella bacteria indicating that Salmonella was completely eliminated.

The solid mass was ground with a meat grinder having a hole size of 2 mm. Sunflower oil and water were both added to the ground mass each in a ratio of 2:10 (w/w) and were left to be absorbed by the mass at 4° C. for 60 minutes. Batches of the mass were then milled with a colloid mill. The colloid milling provides a mass which is a ready-to-consume food product.

Mouthfeel of the food product produced above was examined by a group of five experienced assessors. The food product was tested as a fresh product, and after the food product was frozen for 48 h and thawed to a room temperature. Mouthfeel of both food products was evaluated as appealing and smooth by all assessors.

The mass may also be used as an ingredient of a food composition in an amount up to 50 wt-% of the total weight of the food composition.

### Example 2

The extruded mass was produced as described in Example 1 and colloid milled. The extruded mass was torn to particles having a particle size of about 1-5 mm. Fresh ground chicken meat was added to the particles in a ratio of 65:35 (w/w). Beef fat was added to the obtained mixture in a ratio of 1:10 (w/w) followed by grinding by a meat grinder with a 5 mm sieve to provide a dough.

2.0 wt-% of salt and spices including black pepper powder, hot pepper powder, cumin powder, garlic powder, onion powder and cayenne pepper were added to the dough. The dough was kneaded for about 20 minutes until a smooth mass was obtained. The mass was wrapped in an oil-coated aluminum foil, baked in an oven at 125° C. until the internal temperature of the kebab-like mass was 80° C.

Product was cooled to +4° C. and vacuum packaged.

The resultant kebab-like food product exhibited an appealing taste and mouthfeel.

### Example 3

The extruded mass was produced as described in Example 1 and colloid milled. The solid mass was ground with a meat grinder having a hole size of 2 mm. Sunflower oil and water were both added to the ground mass each in a ratio of 2:10 (w/w) and were left to be absorbed by the mass at 4° C. for 10 minutes. Batches of the mass were then milled with a colloid mill. The colloid milling provides a mass which is a ready-to-consume food product.

### Example 4

93 kg of poultry carcass (with bones and skin) was minced with a meat grinder with a hole size of 2 mm. The ground poultry mass was then colloid milled to a fine mass with bone particles with approximately diameter of 100 μm. Milled mass was properly mixed with 7 kg of a soy concentrate powder (protein content of 66 wt. %). The resultant mixture was kept at approximately 4° C. The mixture was then loaded to a silo connected to a conveyor screw that was connected to a hopper with approximately 30 liters of volume. The mixture was led from the hopper with an auger and a screw to an extruder in a controlled manner at approximately 55 kg/h.

The mixture of ground poultry mass and a soy concentrate powder was led to an extruder which had a cooling die integrated therewith. The moisture content of the mixture was about 55% w/w. The mixture was extruded at 170 rpm. Heating zones of the extruder were adjusted to a temperature of 60° C., 70° C., 80° C., 100° C., 120° C., 150° C. and 170° C. First zone of the cooling die was set to 60° C. and last zone to 40° C. The extrusion process took about one minute.

The extruded mass exited the cooling die at a temperature of less than 100° C. Only a small amount of steam was released in the process. Solid mass and some amounts of separated oil exited the end of the cooling die.

The level of aerobic microorganisms of the solid mass obtained from the wet extrusion and that of the mixture of ground poultry mass and a soy concentrate powder to be fed to the wet extrusion, i.e., “raw material”) were measured at 30° C./72 h. The solid mass showed <100 pmy/g, while the raw material showed more than 30 000 000 pmy/g. The measured level of aerobic microorganisms indicates that a food grade product for human consumption was obtained.

The food product, i.e., solid mass, had a calcium content of 0.9% w/w and protein content of 21% (w/w).

The solid mass exhibited 7-log reduction of Salmonella bacteria indicating that Salmonella was completely eliminated.

The solid mass was ground with a meat grinder having a hole size of 2 mm. Rapeseed oil and water were both added to the ground mass each in a ratio of 2:10 (w/w) and were left to be absorbed by the mass at 4° C. for 10 minutes after mixing. Batches of the mass were then milled with a colloid mill. The colloid milling provides a colloid milled mass which is a ready-to-consume food product.

The collagen content of the resultant ready-to-consume food product was 30% calculated from the total protein content of the food product.

The colloid milled mass was further used in the production of a food composition as follows: Fresh ground chicken meat was added to the colloid milled mass in a ratio of 75:25 (w/w). Then egg was added by ratio of 5:95 and bread crusts by ratio of 5:95 followed by light mixing and grinding by a meat grinder with a 5 mm sieve to provide a dough.

2.0 wt-% of salt and spices including black pepper powder, hot pepper powder, cumin powder, garlic powder, onion powder and cayenne pepper were added to the dough. The dough was kneaded for about 15 minutes until a well-mixed mass was obtained. The mass was formed to balls of about 5 cm. The balls were baked in an oven at 200° C. until the internal temperature of the balls was 80° C.

After baking, the product was cooled to +4° C. and vacuum packaged.

The resultant meatball-like food product exhibited an appealing taste and mouthfeel.

### Water and Oil Binding Test

Extruded solid mass was produced from 93 kg of poultry carcass (with bones and skin) and from 7 kg of soy concentrate powder in the manner described in Example 4. The extruded solid mass was divided into two samples, i.e. mass A and mass B. Mass A was colloid milled after extrusion while mass B was not colloid milled after extrusion. Hence, mass A was colloid milled twice, whereas mass B was colloid milled once.

100 g of water and 100 g of rapeseed oil were added to both masses at 6° C. Masses were stirred and heated to 18° C. during one hour followed by cooling back to 6° C. during nine hours. The masses were placed on a 0.1 mm metal sieve for 5 minutes. The weight of the leaked liquid was measured. This was repeated five times.

The test showed that mass A that had undergone two colloid milling steps bound about 10 g more liquid than mass B that was colloid milled only once before extrusion. Mass A thus exhibited an increased liquid absorption capacity compared with mass B.

### Particle Size Comparison

Particle size of hard tissues of masses A and B was studied. 0.9 g of each mass was diluted in 20 ml of water, thoroughly mixed, and pipetted onto the microscopy slides.

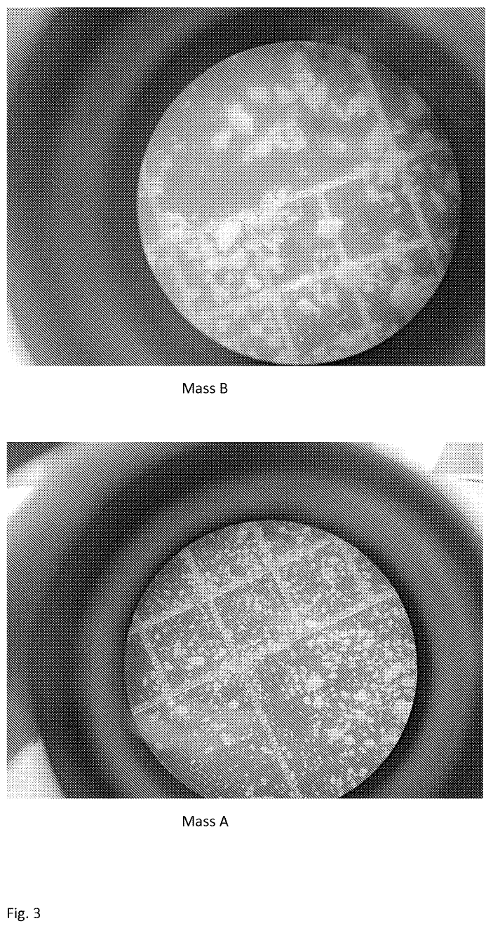

The results are shown in FIG. 3. Mass A contains hard tissue particles of minor size compared with mass B. The second milling after extrusion carried out in the method of the invention decreases the size of hard tissues of the food product.

It will be obvious to a person skilled in the art that, as the technology advances, the inventive concept can be implemented in various ways. The invention and its embodiments are not limited to the examples described above but may vary within the scope of the claims.

1. A method of producing a food product comprising a poultry meat material and a plant-based food material, comprising the steps of:
providing a gutted and plucked poultry meat material comprising bones,
providing a plant-based food material,
grinding the gutted and plucked poultry meat material with a meat grinder having a particle size of at most 5 mm to provide a ground poultry mass,
adding the plant-based food material to the ground poultry mass to provide a poultry/plant mass mixture,
subjecting the poultry/plant mass mixture to a wet extrusion to provide an extruded mass,
mincing the extruded mass with a colloid mill to provide a minced extruded mass as a food product.

2. The method of claim 1, wherein the gutted and plucked poultry meat material is chicken.

3. The method of claim 1, wherein the gutted and plucked poultry meat material contains bones in an amount of about 10 wt-% to about 60 wt-% based on the weight of the gutted and plucked poultry meat material.

4. The method of claim 1, wherein the gutted and plucked poultry meat material further contains at least one of hard tissues, tendons, skin and cartilages.

5. The method of claim 1, wherein the meat grinder has a hole size in the range of about 2 mm up to 5 mm.

6. The method of claim 1, wherein the ground poultry mass is further ground with a colloid mill to provide a colloid milled ground poultry mass.

7. The method of claim 6, wherein the colloid milled ground poultry mass has an average particle size of at most 500 μm.

8. The method of claim 1, wherein the plant-based food material comprises soy protein, pea protein, cereal proteins, broad bean protein, maize protein, or any mixture thereof.

9. The method of claim 1, wherein the plant-based food material is added in an amount so as to provide a food product containing about 5 wt-% to about 50 wt-%, specifically of about 10 wt-% to about 30 wt-%, of the plant-based food material.

10. The method of claim 1, wherein the food product contains about 50 wt-% to about 95 wt-%, specifically of about 70 wt-% to about 90 wt-% of the gutted and plucked poultry meat material.

11. The method of claim 1, wherein the poultry/plant mass mixture is cooled prior to extrusion to a temperature of about −25° C. to about 6° C.

12. The method of claim 1, wherein the wet extrusion is carried out at a temperature of about 100° C. to about 400° C.

13. The method of claim 1, wherein the wet extrusion is performed using about 100 rpm to about 1000 rpm speed, specifically about 170 rpm to about 600 rpm speed, more specifically about 170 rpm.

14. The method of claim 1, wherein the poultry/plant mass mixture has a moisture content of about 30 wt-% to about 70 wt-%.

15. The method of claim 1, wherein at least one of water and oil is added to the extruded mass prior to mincing with a colloid mill.

16. The method of claim 1, wherein the temperature of the extruded mass is at least 100° C.

17. The method of claim 1, wherein the extruded mass is cooled to a temperature of about +60° C. to about −30° C.

18. The method of claim 1, wherein minced extruded mass has an average bone particle size of about 1 μm to about 500 μm.

19. The method of claim 1, wherein the food product has a calcium content of about 0.2% w/w to about 0.9% w/w, specifically 0.2% w/w to about 0.7% w/w, more specifically about 0.2% w/w to about 0.5% w/w, even more specifically about 0.5% w/w to about 0.7% w/w.

20. The method of claim 1, wherein the food product has a collagen content of about 5 wt-% to about 80 wt-%, specifically about 10 wt-% to about 70 wt-%, more specifically about 30 wt-% to about 60 wt-%, based on the total protein content of the food product.

21. The method of claim 1, wherein addition of collagen from an external source is excluded.

22. A food composition comprising a food product produced by the method of claim 1.

23. The food composition of claim 22, wherein the amount of the food product is up to about 50% w/w of the food composition.

24. Use of a food product produced by the method of claim 1 in the food composition.

25. An apparatus comprising means for implementing the method of claim 1.

26. The apparatus of claim 25, wherein the means comprises
a meat grinder for grinding a gutted, plucked poultry meat material to provide a ground poultry mass,
an extruder connected with the meat grinder and configured to receive the ground poultry mass to provide an extruded mass,
a colloid mill connected with the extruder and configured to receive the extruded mass to provide a food product.
